(19) United States
(12) Patent Application Publication
(10) Pub. No.: US 2026/0338535 A1
(43) Pub. Date: Oct. 29, 2026

(54) MULTI-PARAMETER COMPOSITE DISPLACEMENT SENSOR BASED ON TALBOT EFFECT OF OPTICAL GRATING

(71) Applicant: North University of China, Taiyuan (CN)

(72) Inventors: Chenguang Xin, Taiyuan (CN); Haoliang Shi, Taiyuan (CN); Mengwei Li, Taiyuan (CN)

(21) Appl. No.: 19/638,517

(22) Filed: Apr. 3, 2026

(30) Foreign Application Priority Data
Apr. 28, 2025 (CN) 2025105477034

(51) Int. Cl. G01B 9/02001; G01B 11/14

(52) U.S. Cl. CPC G01B 9/0201; G01B 9/02012; G01B 11/14

(57) ABSTRACT

A multi-parameter composite displacement sensor based on Talbot effect of optical grating is provided. A laser beam expander is disposed in the optical path direction of a laser. An upper grating is disposed in the optical path direction of the laser beam expander. A lower grating is disposed in the optical path direction of the upper grating. A detector is disposed in the optical path direction of the lower grating. A processing circuit is connected to the detector through a signal line. Based on the Talbot effect of optical grating, a double-grating, single common-axis optical path configuration is employed. By detecting changes in phase and amplitude of transmitted optical signals behind the two gratings, a relative linear displacement and a relative angular displacement between the two gratings are measured respectively. Optimizing grating structure and using a multi-quadrant detector enables nanometer-level linear displacement resolution and 0.1 mV/arcsec angular sensitivity.

### CROSS-REFERENCE TO RELATED APPLICATION

This application claims priority to Chinese Patent Application No. 202510547703.4, filed on Apr. 28, 2025, which is herein incorporated by reference in its entirety.

### TECHNICAL FIELD

The disclosure relates to the field of optical precision measurement technologies, and more particularly to a multi-parameter composite displacement sensor based on Talbot effect of optical grating.

### BACKGROUND

A multi-parameter composite displacement sensor can simultaneously measure signals such as linear displacement and angular displacement. It is applicable for posture measurement of core moving components including worktables, cutting tools, and probes in precision machining and inspection equipment such as lithography machines, multi-axis machine tools, and multi-degree-of-freedom coordinate machines, directly affecting key indicators such as machining and inspection accuracy of the related equipment.

Currently, conventional multi-parameter composite displacement sensors are mainly based on various methods such as laser interferometry, laser autocollimation, and grating-diffraction interferometry. These methods rely either on the combination of multiple independent sensors or on the use of numerous optical components (e.g., mirrors, wave plates, polarizers) to construct non-coaxial multi-path optical configurations. This results in problems of complex device structure, large assembly volume, poor stability, significant geometric errors, and cross-coupling of errors, making it difficult to meet the demands of high-integration and high-precision applications.

### SUMMARY

In view of technical problems existing in the aforementioned conventional multi-parameter composite displacement sensors, such as complex structure, large assembly volume, poor stability, significant geometric errors, and cross-coupling of errors, the disclosure provides a multi-parameter composite displacement sensor based on Talbot effect of optical grating. Based on Talbot effect of optical grating, the sensor of the disclosure employs a double-grating, single common-axis optical path configuration. By detecting changes in phase and amplitude of transmitted optical signals behind the two gratings simultaneously, a relative linear displacement (perpendicular to the direction of the grating lines) and a relative angular displacement (rotation about an axis parallel to the direction of the grating lines) between the two gratings are measured respectively, which can overcome the problems of complex structure, large assembly volume, poor stability, significant geometric errors, and cross-coupling of errors in the related art.

To solve the technical problems mentioned above, the disclosure adopts the following technical solutions: a multi-parameter composite displacement sensor based on the Talbot effect of optical grating, which includes a laser, a laser beam expander, an upper grating, a lower grating, a detector, and a processing circuit. The laser beam expander is disposed in the optical path (i.e., the optical path direction) of the laser. The upper grating is disposed in the optical path of the laser beam expander. The lower grating, which is also disposed in the same optical path of the laser, is located within the Talbot region behind the upper grating (that's to say, the lower grating is disposed in the optical path direction of the lower grating). The detector is disposed behind the lower grating in the optical path direction. The processing circuit is connected to the detector through a signal line.

In an embodiment, each of the upper grating and the lower grating is made by etching an aluminum film with a thickness in a range of 50 nanometers (nm) to 500 nm, and each of the upper grating and the lower grating is disposed on a silicon dioxide substrate with a thickness in a range of 100 micrometers (μm) to 10 millimeters (mm).

In an embodiment, the laser is configured to emit visible light. The grating period of the upper grating is equal to that of the lower grating. The grating period of each of the upper grating and the lower grating is in a range of 100 nm to 50 μm, and a grating duty cycle of each of the upper grating and the lower grating is 0.5.

In an embodiment, the lower grating has a dual-quadrant structure, and two grating quadrants of the lower grating are located on a substrate and are separated by a spacing of (N+¼) times a grating period of the lower grating, where N represents an integer.

In an embodiment, the multi-parameter composite displacement sensor based on Talbot effect of optical grating further includes a rotation stage and a linear translation stage. The upper grating is mounted on the rotation stage, and the rotation stage is configured to support and rotate the upper grating to provide an angular displacement for the upper grating. The rotation stage is mounted on the linear translation stage, and the linear translation stage is configured to provide a linear displacement for the upper grating.

In an embodiment, the detector is a multi-quadrant detector, and two sinusoidal signals respectively output by two quadrants of the detector have a phase difference of π/2 radians.

In an embodiment, the processing circuit includes a low-pass filter circuit and an interpolation circuit. The low-pass filter circuit with a cutoff frequency of 50 Hertz (Hz) is electrically connected to the detector through the signal line. The interpolation circuit is electrically connected to the low-pass filter circuit, and an interpolation factor C of the interpolation circuit is in a range of 100 to 10,000.

A measurement method, implemented by the multi-parameter composite displacement sensor based on Talbot effect of optical grating, includes the following steps:
S1, expanding, by the laser beam expander, an optical beam emitted by the laser to increase a diameter of the optical beam, thereby to obtain an expanded optical beam, and illuminating the expanded optical beam onto an upper surface of the upper grating to generate a Talbot field behind the upper grating;
S2, positioning the lower grating within the region of the Talbot field behind the upper grating and on the optical axis of the incident optical beam, modulating, by the lower grating, the incident optical beam to obtain a modulated optical beam, and illuminating the modulated optical beam onto the detector;
S3, rotating the upper grating about a y axis, which is parallel to the direction of the grating lines, by an angle θ to change a relative position between the upper grating and the lower grating, thereby changing the optical field distribution and the transmitted light intensity behind the lower grating, resulting in amplitude changes of sine and cosine analog electrical signals output by the detector, and measuring the angular displacement of the upper grating by detecting the amplitude changes;
where the measuring the angular displacement of the upper grating by detecting the amplitude changes in the step 3 is implemented by the following formula:

$$U ( x , z , θ ) = exp ( ikz ) {\sum }_{n = - ∞}^{∞} {C}_{n} exp ( i 2 π n / d cos θ )$$

where U(x,z,θ) represents a complex amplitude of the optical field behind the lower grating after the upper grating rotates about the y axis by the angle θ, x represents a transverse coordinate in the plane of the upper grating, z represents a longitudinal coordinate along a propagation direction of the expanded optical beam, k represents the wavenumber of the expanded optical beam, Cₙ represents a Fourier coefficient of the upper grating, n represents diffraction order of the upper grating, d represents the grating period of the upper grating, θ represents the angular displacement of the upper grating about the y axis, and the angular displacement θ is calculated based on the amplitude change of the complex amplitude U(x,z,θ);
S4, translating the upper grating by a distance ΔL in x axis, which is the direction perpendicular to the direction of grating lines of the upper grating (i.e., translating the upper grating in-plane by a distance ΔL in a direction perpendicular to a direction of grating lines of the upper grating), to change the relative position between the upper grating and the lower grating, thereby changing the optical field distribution and the transmitted light intensity behind the lower grating, resulting in phase changes of the sine and cosine analog electrical signals output by the detector, and measuring the in-plane linear displacement of the upper grating by detecting the phase changes.

In an embodiment, in the step 1, a process for generating the Talbot field includes the following steps:
S1.1, adjusting a relative position between the laser beam expander and the laser to make the expanded optical beam be collimated;
S1.2, adjusting a position of the upper grating relative to the expanded optical beam to make the grating region of the upper grating be covered by the expanded optical beam;
S1.3, imaging the optical field behind the upper grating by using an imaging device including a charge-coupled device (CCD) or a complementary metal-oxide-semiconductor (CMOS) detector to obtain an imaged structure of the optical field behind the upper grating, and determining, when the imaged structure is consistent with the grating structure of the upper grating and the period of the imaged structure is equal to the grating period of the upper grating, the optical field as the Talbot field;
S1.4, determining, when a monochromatic plane wave (i.e., the expanded optical beam) is normally incident on the upper grating, the optical field distribution behind the upper grating U(x,z) as follows:

$$U ( x , z ) = {\sum }_{n = - ∞}^{∞} {C}_{n} exp ( i 2 π n / d )$$

where U(x,z) represents the complex amplitude of the optical field behind the upper grating after the monochromatic plane wave is normally incident on the upper grating, x represents a transverse coordinate in the plane of the upper grating, z represents a longitudinal coordinate along the propagation direction of the monochromatic plane wave, Cₙ represents the Fourier coefficient of the upper grating, and d represents the grating period of the upper grating.

In an embodiment, the measuring an in-plane linear displacement of the upper grating by detecting the phase changes in the step 4 is implemented by the following formula:

$${U}^{′} ( x , z , Δ L ) = exp ( ikz ) {\sum }_{n = - ∞}^{∞} {\sum }_{n = - ∞}^{∞} {C}_{n} {C}_{m} exp ( i 2 π \frac{n / cos θ + m}{d} x ) exp ( i 2 π \frac{n / cos θ}{d} Δ L )$$

where U′(x,z,ΔL) represents the complex amplitude of the optical field behind the lower grating when the upper grating has a relative linear displacement from the lower grating, Cₘ represents a Fourier coefficient of the lower grating, m represents diffraction order of the lower grating, ΔL represents the relative linear displacement between the upper grating and the lower grating, and the relative linear displacement ΔL is calculated based on the phase change of U′(x,z,ΔL).

Compared with the related art, the disclosure solves the problems of complex structure, large assembly volume, poor stability, significant geometric errors, and cross-coupling of errors. By optimizing the grating structure and using the multi-quadrant detector, the disclosure achieves a linear displacement measurement resolution of nanometer level and an angle measurement sensitivity of 0.1 millivolts per arc second (mV/arcsec). Owing to these beneficial effects, this multi-parameter composite displacement sensor based on Talbot effect of optical grating is suitable for applications requiring simultaneous high-precision measurement of linear and angular displacements, such as in semiconductor lithography and precision mechanical positioning.

### BRIEF DESCRIPTION OF DRAWINGS

To more clearly illustrate technical solutions of embodiments of the disclosure or in the related art, attached drawings used in the description of the embodiments or the related art will be briefly introduced below. Apparently, the attached drawings in the following description are merely exemplary. For those skilled in this art, other illustrative attached drawings can be derived based on the provided attached drawings without making creative efforts.

The structures, proportions, sizes, and other features illustrated in the specification are intended only to complement the content disclosed herein for the understanding and reference of those skilled in the art. They are not intended to impose limitations on implementable conditions of the disclosure and therefore hold no substantive technical significance. Any modification to the structures, adjustment to proportional relationships, or change in the sizes shall remain within the scope of the technical content disclosed in the disclosure, provided that such alterations do not affect the intended effects and purposes achievable by the disclosure.

FIG. 1 illustrates a schematic structural diagram of the multi-parameter composite displacement sensor based on Talbot effect of optical grating of the disclosure.

FIG. 2 illustrates a schematic structural diagram to show the positional relationship between the upper grating, the rotation stage, and the linear translation stage.

FIG. 3 illustrates a schematic diagram of the inside modules of the processing circuit.

FIG. 4 illustrates a schematic structural diagram of two gratings of the disclosure.

FIG. 5 illustrates a schematic diagram of simulated optical transmission characteristics of the disclosure.

FIG. 6 illustrates a schematic diagram of the curve of normalized transmitted intensity versus angle θ of the disclosure.

FIG. 7 illustrates a schematic diagram of the curves of normalized transmitted intensity versus linear displacement at different θ values of the disclosure.

FIG. 8 illustrates a schematic diagram of experimental results of the disclosure.

FIGS. 9A-9B illustrate schematic diagrams of comparison of displacement measurement results of the disclosure. Specifically, FIG. 9A illustrates a schematic diagram of linear displacement measurement results within 160-μm range in an experiment of the disclosure. FIG. 9B illustrates a schematic diagram of multiple measurement results with an input linear displacement of approximately 100 μm of the disclosure.

FIG. 10 illustrates a schematic diagram of an angular-amplitude calibration curve of the disclosure.

### DESCRIPTION OF REFERENCE SIGNS

1-laser; 2-laser beam expander; 3-upper grating; 4-lower grating; 5-detector; 6-processing circuit; 7-rotation stage; 8-linear translation stage.

### DETAILED DESCRIPTION OF EMBODIMENTS

To make purposes, technical solutions, and advantages of embodiments of the disclosure clearer, the technical solutions in the embodiments of the disclosure will be described clearly and completely below. It is apparent that described embodiments are merely some embodiments of the disclosure, rather than all embodiments of the disclosure. These descriptions are intended to further illustrate the features and advantages of the disclosure and are not intended to limit the scope of the appended claims of the disclosure. Based on the described embodiments in the disclosure, all other embodiments obtained by those skilled in the art without creative efforts shall fall within the scope of protection of the disclosure.

Specific implementation manners of the disclosure are further described in detail below with reference to attached drawings and the embodiments. The embodiments are intended to illustrate the disclosure, but are not intended to limit the scope of the disclosure.

In the description of the disclosure, it should be noted that, unless otherwise explicitly specified and defined, terms “mount”, “connect”, and “couple” should be interpreted broadly. For example, they may refer to a fixed connection, a detachable connection, or an integral connection; they may indicate a mechanical connection or an electrical connection; and they may refer to a direct connection or an indirect connection through an intermediate medium, or may also refer to internal communication between two elements. For those of skilled in the art, specific meanings of the above terms in the disclosure can be understood according to specific circumstances.

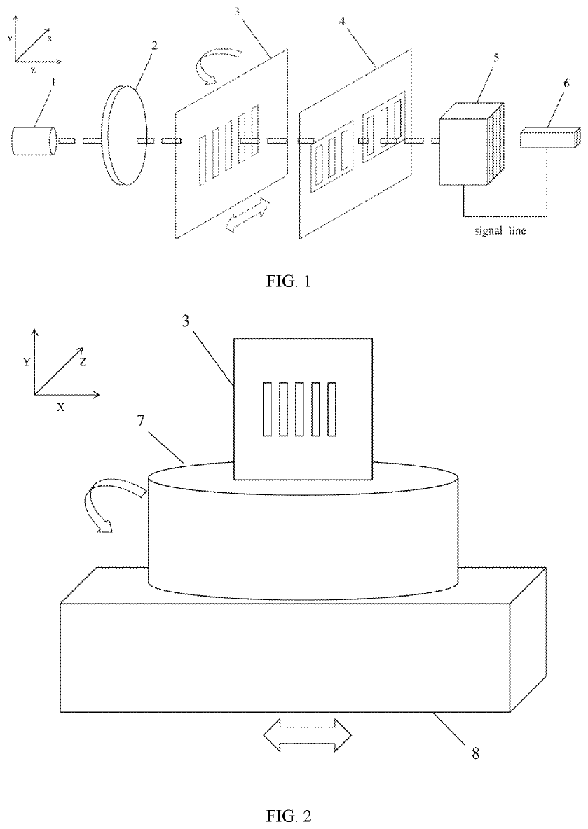

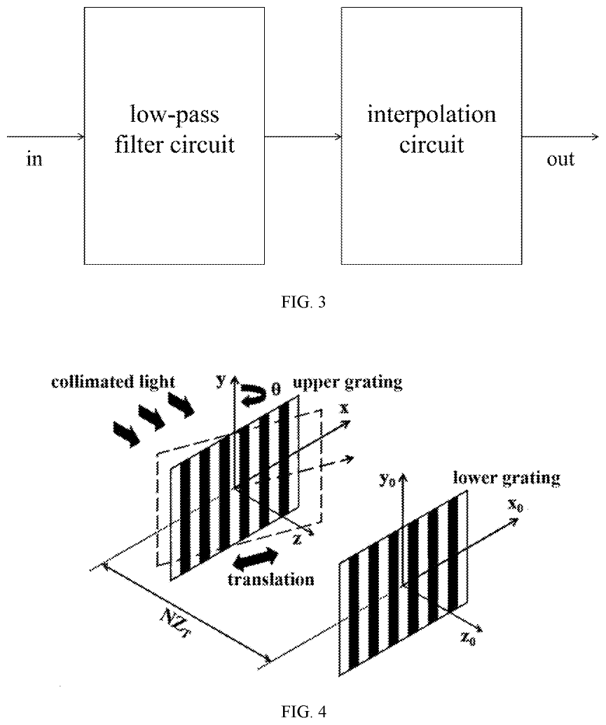

An embodiment of the disclosure provides a multi-parameter composite displacement sensor based on Talbot effect of optical grating, as shown in FIGS. 1 and 2, which includes a laser 1, a laser beam expander 2, an upper grating 3, a lower grating 4, a detector 5, and a processing circuit 6. The upper grating 3 is mounted on a rotation stage 7, and the rotation stage 7 is configured to support and rotate the upper grating 3 to provide angular displacement for the upper grating. The rotation stage 7 is mounted on a linear translation stage 8, and the linear translation stage 8 is configured to provide a linear displacement for the upper grating.

An optical beam emitted by the laser 1 is expanded by the laser beam expander 2 to increase the diameter of the light beam, thereby to obtain an expanded light beam. Then the expanded light beam is illuminated onto the upper surface of the upper grating 3 to generate a Talbot field behind the upper grating 3 (this process is referred to as the first modulation process). The lower grating 4 is positioned within the region of the Talbot field behind the upper grating 3 and on the optical axis of the incident optical beam from the upper grating 3. This field is modulated by the lower grating 4 to obtain a modulated optical beam (this process is called as the second modulation process). Then the modulated optical beam is illuminated onto the detector 5. The detector 5 is a multi-quadrant detector, and two sinusoidal signals output by two quadrants of the detector 5 respectively have a phase difference of π/2 radians. The processing circuit 6 includes a low-pass filter circuit and an interpolation circuit, and the interpolation factor C of the interpolation circuit is adjustable in a range of 100 to 10,000. Specifically, a cutoff frequency of the low-pass filter circuit is 50 Hz.

During operation, steps for generating the Talbot field behind the upper grating 3 are as follows. Firstly, the relative position between the laser beam expander 2 and the laser 1 is adjusted to make the expanded optical beam (i.e., an output optical beam of the laser beam expander 2) be collimated. Then, the position of the upper grating relative to the expanded optical beam is adjusted to make the grating region of the upper grating 3 be covered by the expanded optical beam. Subsequently, the optical field behind the upper grating 3 is imaged by using an imaging device such as a CCD or a CMOS detector to obtain an imaged structure of the optical field, and when the imaged structure is consistent with the grating structure of the upper grating 3 and the period of the imaged structure is equal to the grating period of the upper grating 3, the optical field is determined as the Talbot field.

When the upper grating 3 is rotated about y axis by an angle θ and simultaneously translated in x axis by a distance of ΔL, the relative position between the upper grating 3 and the lower grating 4 is changed, which changes the optical field distribution and transmitted light intensity behind the lower grating 4, resulting in amplitude changes and phase changes of sine and cosine analog electrical signals output by the detector 5. By detecting the amplitude changes and phase changes, a relative angular displacement and a relative linear displacement between the upper grating 3 and the lower grating 4 are measured, respectively.

Specifically, as shown in FIG. 4, a spacing between the upper grating 3 and the lower grating 4 satisfies a Talbot-imaging condition expressed as that: NZ_{T}=2Nd²/φ, thereby ensuring that transmitted light forms stable interference fringes. In the above formula, Zr represents the period of the Talbot images in z axis, d represents the grating period of the upper grating 3, and φ represents wavelength of the incident optical beam from the laser 1.

After a monochromatic plane wave (i.e., the expanded optical beam) is normally incident on the upper grating 3, an optical field distribution behind the upper grating 3 (i.e., a distribution of the optical field behind the upper grating 3) is expressed as follows:

$$U ( x , z ) = {\sum }_{n = - ∞}^{∞} {C}_{n} exp ( i 2 π n / d )$$

where U(x,z) is the complex amplitude of the optical field behind the upper grating 3 after the monochromatic plane wave is normally incident on the upper grating 3, x represents a transverse coordinate in the plane of the upper grating 3, z represents a longitudinal coordinate along the propagation direction of the monochromatic plane wave, Cₙ represents a Fourier coefficient of the upper grating 3, n represents diffraction order of the upper grating 3, and d represents the grating period of the upper grating 3.

After the upper grating 3 rotates about the y axis by the angle θ, the optical field distribution behind the lower grating 4 is expressed as follows:

$$U ( x , z , θ ) = exp ( ikz ) {\sum }_{n = - ∞}^{∞} {C}_{n} exp ( i 2 π n / d cos θ )$$

where U(x,z,θ) represents a complex amplitude of an optical field behind the lower grating after the upper grating 3 rotates about y axis by the angle of θ, θ represents the angular displacement of the upper grating 3 about the y axis, and the angular displacement θ is calculated based on an amplitude change of the complex amplitude U(x,z,θ).

After the upper grating 3 is translated in x axis by the distance of ΔL in the direction perpendicular to the direction of grating lines, the optical field distribution behind the lower grating 4 is expressed as follows:

$${U}^{′} ( x , z , Δ L ) = exp ( ikz ) {\sum }_{n = - ∞}^{∞} {\sum }_{n = - ∞}^{∞} {C}_{n} {C}_{m} exp ( i 2 π \frac{n / cos θ + m}{d} x ) exp ( i 2 π \frac{n / cos θ}{d} Δ L )$$

where U′(x,z,ΔL) represents the complex amplitude of the optical field behind the lower grating 4 after the upper grating 3 has a relative linear displacement from the lower grating 4, Cₘ represents a Fourier coefficient of the lower grating 4, m represents diffraction order of the lower grating 4, and the relative linear displacement ΔL is calculated based on the phase change of the complex amplitude U′(x,z,ΔL).

Based on the above, the multi-parameter composite displacement sensor based on Talbot effect of optical grating includes a main structure, and the main structure includes the laser 1, the laser beam expander 2, the upper grating 3, the lower grating 4, the detector 5, and the processing circuit 6. The upper grating 3 is mounted on the rotation stage 7 to provide an angular displacement for the upper grating 3. The rotation stage 7 is mounted on the linear translation stage 8 to provide a linear displacement for the upper grating 3. During operation, the expanded optical beam output from the laser beam expander 2 illuminates the upper surface of the upper grating 3, generating the Talbot field behind the upper grating 3. The lower grating 4 is positioned within the region of the Talbot field of the upper grating 3 to perform the second modulation process on the input beam, thereby to obtain the modulated optical beam. The modulated optical beam is then illuminated onto the detector 5. By detecting the amplitude changes and the phase changes of the sine and cosine analog electrical signals output by the detector 5, simultaneous measurement of the angular displacement and the linear displacement of the upper grating 3 is achieved within a single integrated structure.

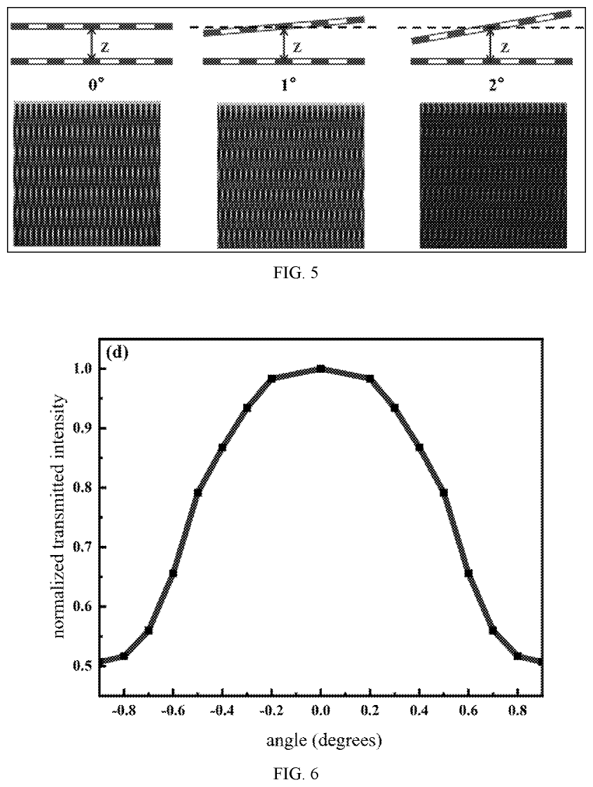

Specifically, as shown in FIG. 5, simulated light transmission under different θ values in an experiment are shown. Specific implementation parameters are as follows. A wavelength of an incident light (i.e., the light beam emitted by the laser 1) is 635 nm; a material of each of the upper grating 3 and the lower grating 4 is aluminum; a grating period of each of the upper grating 3 and the lower grating 4 is 4 μm; and a grating duty cycle of each of the upper grating 3 and the lower grating 4 is 0.5.

A detailed analysis is as follows.

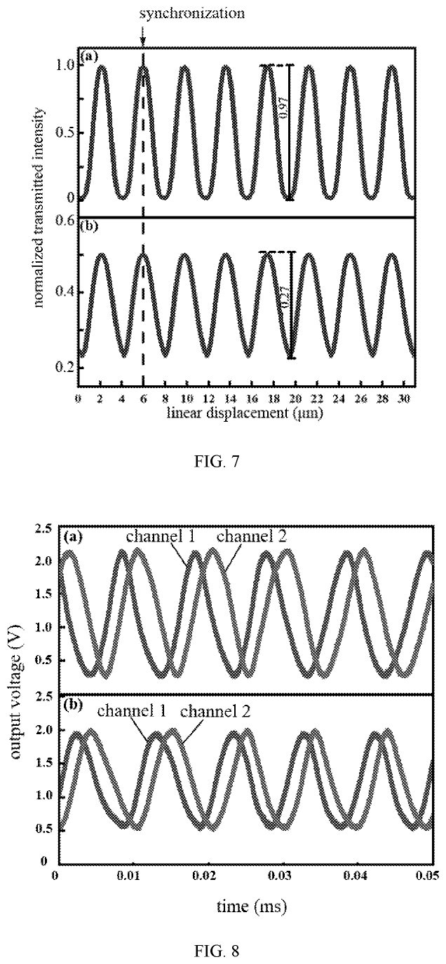

The optical transmission characteristics of a double-grating structure are analyzed by using a finite-difference time-domain (FDTD) method. In the simulation, a plane-wave source with a wavelength of 635 nm is employed, and the two gratings each has the duty cycle of 50%. The lower grating 4 is positioned at a Talbot distance behind the upper grating (Z=N·Z_{T}, where N=1, 2, 3 . . . ). As shown in FIG. 5, the optical transmittance decreases as θ increases gradually from 0° to 2°. As shown in FIG. 6, the normalized transmitted intensity reaches a maximum value of 1 when θ is 0°. As |θ| increases, the normalized transmitted intensity also decreases. As shown in FIG. 7, when there is a relative linear displacement between the upper grating 3 and the lower grating 4 along the direction perpendicular to the direction of each grating line, the transmitted intensity varies sinusoidally with the input linear displacement in both considered cases (including θ is 0° and θ is 1°). However, variations in θ lead to different signal amplitudes. When θ changes from 0° to 1°, the amplitude of the sinusoidal signal (i.e., the normalized transmitted intensity) decreases from 0.97 to 0.27. Specifically, in FIG. 7, (a) illustrates a curve of transmitted intensity versus linear displacement when θ is 0°, and (b) illustrates a curve of transmitted intensity versus linear displacement when θ is 1°.

As shown in FIG. 8, the multi-quadrant detector outputs sinusoidal signals under different values of θ. When θ changes from 0° to 1°, the amplitude of the output signal decreases from 1.88 volts (V) to 1.4 V. Under a constant-velocity linear displacement input, the phase of the signals also changes simultaneously, which is consistent with the simulation results. Specifically, in FIG. 8, (a) illustrates experimental results when θ is 0°, and (b) illustrates experimental results when θ is 1°.

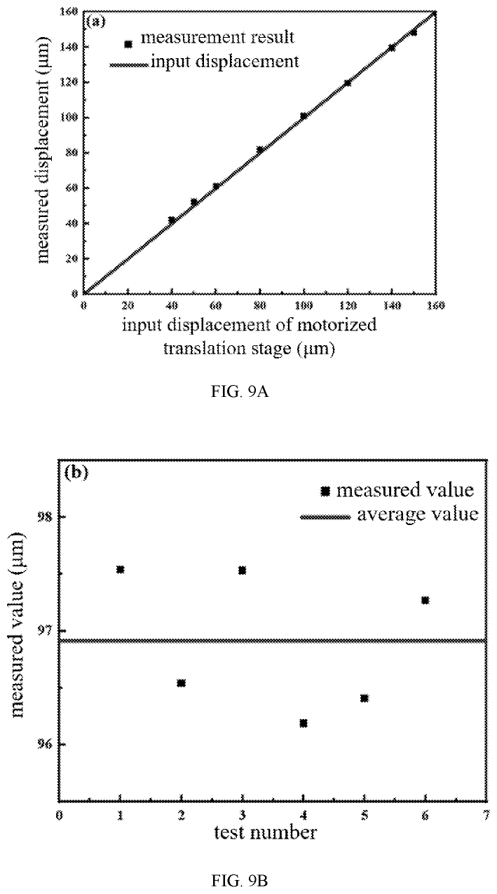

As shown in FIGS. 9A-9B, FIG. 9A illustrates linear displacement measurement results obtained from the experiment. The square symbols (in actual practice, the square symbols are black) represent the results from the proposed sensor, and the line (in actual practice, the line is red) indicates the input displacement, and FIG. 9B illustrates the results of multiple measurements when the input linear displacement is approximately 100 μm. The square symbols (in actual practice, the square symbols are black) represent the measurement results, and the line (in actual practice, the line is red) indicates the average value. The resolution(S) of the displacement measurement can be expressed as: S=d cos θ/C, where C is the interpolation factor of the interpolation circuit. Given that θ is small, the calculated resolution for linear displacement is 4 μm/1000=4 nm.

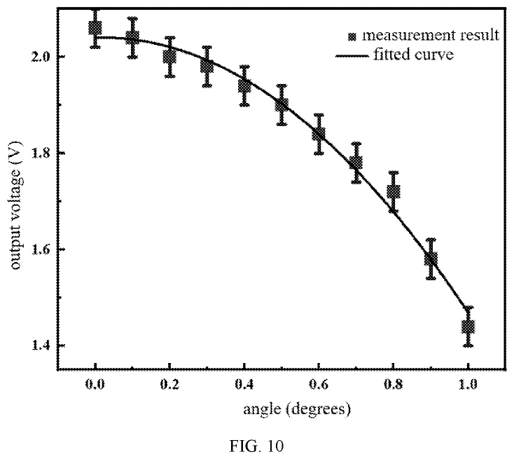

As shown in FIG. 10, a relationship between the rotation angle of the upper grating 3 and the amplitude of the output signal from the detector 5 is presented. The square symbols (in actual practice, the square symbols are red) represent the measured results, and the line (in actual practice, the line is black) represents the fitted curve. The results indicate that as the rotation angle (e.g., angular displacement) increases, the amplitude of the output signal exhibits a decreasing trend, which is consistent with the simulation results. The maximum slope obtained from the fitted curve is 0.92 volts per degree, with a goodness of fit (R²) of 0.98969, thereby yielding a maximum sensitivity as high as 0.26 millivolts per arcsecond.

The above only provides a detailed description of specific embodiments of the disclosure. However, the disclosure is not limited to the above specific embodiments. Within the scope of knowledge possessed by those skilled in the art, various modifications may be made without departing from the spirit of the disclosure, and all such modifications shall fall within the scope of protection of the disclosure.

What is claimed is:

1. A multi-parameter composite displacement sensor based on Talbot effect of optical grating, comprising: a laser (1), a laser beam expander (2), an upper grating (3), a lower grating (4), a detector (5), and a processing circuit (6);
wherein the laser beam expander (2) is disposed in an optical path direction of the laser (1), the upper grating (3) is disposed in an optical path direction of the laser beam expander (2), the lower grating (4) is disposed in an optical path direction of the upper grating (3), the detector (5) is disposed in an optical path direction of the lower grating (4), and the processing circuit (6) is connected to the detector (5) through a signal line.

2. The multi-parameter composite displacement sensor based on Talbot effect of optical grating as claimed in claim 1, wherein each of the upper grating (3) and the lower grating (4) is made by etching an aluminum film with a thickness in a range of 50 nanometers (nm) to 500 nm, and each of the upper grating (3) and the lower grating (4) is disposed on a silicon dioxide substrate with a thickness in a range of 100 micrometers (μm) to 10 millimeters (mm).

3. The multi-parameter composite displacement sensor based on Talbot effect of optical grating as claimed in claim 1, wherein the laser (1) is configured to emit visible light, a grating period of each of the upper grating (3) and the lower grating (4) is in a range of 100 nm to 50 μm, and a grating duty cycle of each of the upper grating (3) and the lower grating (4) is 0.5.

4. The multi-parameter composite displacement sensor based on Talbot effect of optical grating as claimed in claim 1, wherein the lower grating (4) has a dual-quadrant structure, and two grating quadrants of the lower grating (4) are located on a substrate and are separated by a spacing of (N+¼) times a grating period of the lower grating (4), where N represents an integer.

5. The multi-parameter composite displacement sensor based on Talbot effect of optical grating as claimed in claim 1, further comprising a rotation stage (7) and a linear translation stage (8), wherein the upper grating (3) is mounted on the rotation stage (7), and the rotation stage (7) is configured to support and rotate the upper grating (3) to provide an angular displacement for the upper grating (3); and the rotation stage (7) is mounted on the linear translation stage (8), and the linear translation stage (8) is configured to provide a linear displacement for the upper grating (3).

6. The multi-parameter composite displacement sensor based on Talbot effect of optical grating as claimed in claim 1, wherein the detector (5) is a multi-quadrant detector, and two sinusoidal signals respectively output by two quadrants of the detector (5) have a phase difference of π/2 radians.

7. The multi-parameter composite displacement sensor based on Talbot effect of optical grating as claimed in claim 1, wherein the processing circuit (6) comprises a low-pass filter circuit and an interpolation circuit, the low-pass filter circuit with a cutoff frequency of 50 Hertz (Hz) is electrically connected to the detector (5) through the signal line, the interpolation circuit is electrically connected to the low-pass filter circuit, and an interpolation factor C of the interpolation circuit is in a range of 100 to 10,000.

8. A measurement method, implemented by the multi-parameter composite displacement sensor based on Talbot effect of optical grating as claimed in claim 1, and the measurement method comprising the following steps:
S1, expanding, by the laser beam expander (2), an optical beam emitted by the laser (1) to increase a diameter of the optical beam, thereby to obtain an expanded optical beam, and illuminating the expanded optical beam onto an upper surface of the upper grating (3) to generate a Talbot field behind the upper grating (3);
S2, positioning the lower grating (4) within a region of the Talbot field behind the upper grating (3) and on an optical axis of an incident optical beam from the upper grating (3), modulating, by the lower grating (4), the incident optical beam to obtain a modulated optical beam, and illuminating the modulated optical beam onto the detector (5);
S3, rotating the upper grating (3) about a y axis by an angle θ to change a relative position between the upper grating (3) and the lower grating (4), thereby changing an optical field distribution and a transmitted light intensity behind the lower grating (4), resulting in amplitude changes of sine and cosine analog electrical signals output by the detector (5), and measuring an angular displacement of the upper grating (3) by detecting the amplitude changes;
wherein the measuring an angular displacement of the upper grating (3) by detecting the amplitude changes in the step 3 is implemented by the following formula:
$$U ( x , z , θ ) = exp ( ikz ) {\sum }_{n = - ∞}^{∞} {C}_{n} exp ( i 2 π n / d cos θ )$$
where U(x,z,θ) represents a complex amplitude of an optical field behind the lower grating (4) after the upper grating (3) rotates about the y axis by the angle θ, x represents a transverse coordinate in a plane of the upper grating (3), z represents a longitudinal coordinate along a propagation direction of the expanded optical beam, k represents a wavenumber of the expanded optical beam, Cₙ represents a Fourier coefficient of the upper grating (3), n represents diffraction order of the upper grating (3), d represents a grating period of the upper grating (3), θ represents the angular displacement of the upper grating (3) about the y axis, and the angular displacement θ is calculated based on an amplitude change of the complex amplitude U(x,z,θ); and
S4, translating the upper grating (3) in-plane by a distance ΔL in a direction perpendicular to a direction of grating lines of the upper grating (3) to change the relative position between the upper grating (3) and the lower grating (4), thereby changing the optical field distribution and the transmitted light intensity behind the lower grating (4), resulting in phase changes of the sine and cosine analog electrical signals output by the detector (5), and measuring an in-plane linear displacement of the upper grating (3) by detecting the phase changes.

9. The measurement method for the multi-parameter composite displacement sensor based on Talbot effect of optical grating as claimed in claim 8, wherein in the step S1, a process for generating the Talbot field comprises the following steps:
S1.1, adjusting a relative position between the laser beam expander (2) and the laser (1) to make the expanded optical beam be collimated;
S1.2, adjusting a position of the upper grating (3) relative to the expanded optical beam to make a grating region of the upper grating (3) be covered by the expanded optical beam;
S1.3, imaging an optical field behind the upper grating (3) by using an imaging device comprising a charge-coupled device (CCD) or a complementary metal-oxide-semiconductor (CMOS) detector to obtain an imaged structure of the optical field behind the upper grating (3), and determining, when the imaged structure is consistent with a grating structure of the upper grating (3) and a period of the imaged structure is equal to a grating period of the upper grating (3), the optical field as the Talbot field; and
S1.4, determining, when a monochromatic plane wave is normally incident on the upper grating (3), an optical field distribution behind the upper grating (3) expressed as follows:
$$U ( x , z ) = {\sum }_{n = - ∞}^{∞} {C}_{n} exp ( i 2 π n / d )$$
where U(x,z) represents a complex amplitude of the optical field behind the upper grating (3) after the monochromatic plane wave is normally incident on the upper grating (3), x represents a transverse coordinate in a plane of the upper grating (3), z represents a longitudinal coordinate along a propagation direction of the monochromatic plane wave, Cₙ represents the Fourier coefficient of the upper grating (3), and d represents the grating period of the upper grating (3).

10. The measurement method for the multi-parameter composite displacement sensor based on Talbot effect of optical grating as claimed in claim 8, wherein the measuring an in-plane linear displacement of the upper grating (3) by the detecting the phase changes in the step 4 is implemented by the following formula:
$${U}^{′} ( x , z , Δ L ) = exp ( ikz ) {\sum }_{n = - ∞}^{∞} {\sum }_{n = - ∞}^{∞} {C}_{n} {C}_{m} exp ( i 2 π \frac{n / cos θ + m}{d} x ) exp ( i 2 π \frac{n / cos θ}{d} Δ L )$$
where U′(x,z,ΔL) represents a complex amplitude of the optical field behind the lower grating (4) after the upper grating (3) has a relative linear displacement from the lower grating (4), Cₘ represents a Fourier coefficient of the lower grating (4), m represents diffraction order of the lower grating (4), ΔL represents the relative linear displacement between the upper grating (3) and the lower grating (4), and the relative linear displacement ΔL is calculated based on a phase change of the complex amplitude U′(x,z,ΔL).
